(19) United States
(12) Patent Application Publication
(10) Pub. No.: US 2026/0043923 A1
(43) Pub. Date: Feb. 12, 2026

(54) SYSTEM AND METHOD FOR OUTPUTTING PSEUDO-GNSS SIGNAL IN TUNNEL

(71) Applicant: IDCITI.COM, Incheon (KR)

(72) Inventors: Jihoon RYOO, Incheon (KR); Hongjin LEE, Incheon (KR); In-sun KIM, Incheon (KR); Seonghoon PARK, Incheon (KR); Hamin LIM, Incheon (KR); Jisu RYU, Incheon (KR)

(21) Appl. No.: 19/004,059

(22) Filed: Dec. 27, 2024

(30) Foreign Application Priority Data
Aug. 12, 2024 (KR) 10-2024-0107782

(51) Int. Cl. G01S 19/12; G01S 13/86; G01S 13/92

(52) U.S. Cl. CPC G01S 19/12; G01S 13/86; G01S 13/92

(57) ABSTRACT

A pseudo-GNSS signal output system is proposed. The pseudo-GNSS signal output system may include a main device installed outside a tunnel and a plurality of remote devices installed inside the tunnel at a first interval and configured to communicate with the main device. Each of the plurality of remote devices may include a RADAR device, at least one pseudo-GNSS signal output device, a communication module configured to communicate with the main device, and a processor. The processor may recognize a location and velocity of a vehicle traveling in the tunnel by using the RADAR signal detected by the RADAR device, transmit the recognized location and velocity of the vehicle to the main device, receive pseudo-GNSS signal information from the main device, and generate and output a pseudo-GNSS signal through the at least one pseudo-GNSS signal output device by using the pseudo-GNSS signal information.

### CROSS-REFERENCE TO RELATED APPLICATION

This application is based on and claims priority under 35 U.S.C. § 119 to Korean Patent Application No. 10-2024-0107782, filed on Aug. 12, 2024, in the Korean Intellectual Property Office, the disclosure of which is incorporated by reference herein in its entirety.

### BACKGROUND

### 1. Field

Embodiments of the disclosure relate to a pseudo-global navigation satellite system (GNSS) signal output system for outputting a pseudo-GNSS signal in a tunnel and a pseudo-GNSS signal output method thereof.

### 2. Description of the Related Art

A global navigation satellite system (GNSS) is technology that calculates location information of a receiver, based on information received from satellites. Examples of the GNSS include the United States' global positioning system (GPS), Russia's global navigation satellite system (GLONASS), the European Union's Galileo system, China's Beidou, Japan's quasi-zenith satellite system (QZSS), and India's Indian regional navigation satellite system (IRNSS).

### SUMMARY

Additional aspects will be set forth in part in the description which follows and, in part, will be apparent from the description, or may be learned by practice of the presented embodiments of the disclosure.

According to an aspect of the disclosure, there is provided a pseudo-global navigation satellite system (GNSS) signal output system. The pseudo-GNSS signal output system includes a main device installed outside a tunnel and a plurality of remote devices installed inside the tunnel at a first interval and configured to communicate with the main device. Each of the plurality of remote devices includes a radio detection and ranging (RADAR) device configured to output a RADAR signal and detect a RADAR signal reflected from a target, at least one pseudo-GNSS signal output device, a communication module configured to communicate with the main device, and a processor. The processor is configured to recognize a location and velocity of a vehicle traveling in the tunnel by using the RADAR signal detected by the RADAR device, transmit the recognized location and velocity of the vehicle to the main device through the communication module, receive pseudo-GNSS signal information from the main device through the communication module, and generate and output a pseudo-GNSS signal through the at least one pseudo-GNSS signal output device by using the pseudo-GNSS signal information.

In addition, the main device may be configured to determine an angle magnitude of an azimuth and output power of a GNSS antenna that outputs the pseudo-GNSS signal based on the location and velocity of the vehicle received from each of the plurality of remote devices, and the pseudo-GNSS signal information may include the angle magnitude of the azimuth and the output power.

In addition, according to an embodiment, the main device may be configured to communicate with each of the plurality of remote devices through an optical fiber cable, transmit a delay measurement message for measuring an optical delay to each of the plurality of remote devices, receive a response message to the delay measurement message, measure the optical delay between each of the plurality of remote devices and the main device, based on the response message, and transmit the pseudo-GNSS signal information based on the optical delay.

In addition, according to an embodiment, the main device may be further configured to generate a coarse/acquisition (C/A) code by reflecting the optical delay of each of the plurality of remote devices into GNSS signal information received from a server, and generate the pseudo-GNSS signal information including the generated C/A code.

In addition, according to an embodiment, the main device may be configured to generate the pseudo-GNSS signal in a form of in-phase and quadrature (IQ) modulated in a form of quadratic phase-shift keying (QPSK), and the pseudo-GNSS signal may include a C/A code in a Q phase and a C/A code and an arbitrary P code in an I phase.

In addition, according to an embodiment, the pseudo-GNSS signal output system may further include a plurality of directional GNSS antennas respectively corresponding to lanes of a road in the tunnel and configured to output a pseudo-GNSS signal to a corresponding lane, and the pseudo-GNSS signal may include lane information.

In addition, according to an embodiment, the pseudo-GNSS signal output system may further include a forward GNSS antenna configured to output a pseudo-GNSS signal forward and a backward GNSS antenna configured to output a pseudo-GNSS signal backward.

In addition, according to an embodiment, the processor of each of the plurality of remote devices may be further configured to recognize the velocity of the vehicle traveling in each lane in the tunnel by using the RADAR signal and transmit the recognized velocity of the vehicle for each lane to the main device through the communication module, and the main device may be configured to adjust an angle magnitude of an azimuth and output power of the GNSS antenna of each of the plurality of remote devices, based on the recognized velocity of the vehicle in each lane.

In addition, according to an embodiment, each of the plurality of remote devices may include a camera, and the processor may be further configured to recognize the location, velocity, and licensed plate number of the vehicle traveling in the tunnel, based on the RADAR signal detected by the RADAR device and an image captured by the camera, and transmit the recognized location, velocity, and licensed plate number of the vehicle to the main device.

In addition, according to an embodiment, each of the plurality of remote devices may further include a Bluetooth Low Energy (BLE) device configured to output a Bluetooth signal, and the vehicle in the tunnel may be configured to store BLE map information including location and identification information of the BLE device of each of the plurality of remote devices, calculate an angle at which a Bluetooth signal is received from the BLE device, by using the BLE map information and a received signal strength indicator (RSSI) phase of the Bluetooth signal output from the BLE device, and measure a distance from the BLE device by using the BLE map information and an RSSI value.

In addition, according to an embodiment, each of the plurality of remote devices may further include an Ultra-Wideband (UWB) device configured to output a UWB signal, and the vehicle in the tunnel may be configured to store UWB map information including location and identification information of the UWB device of each of the plurality of remote devices and detect the location of the vehicle by using the UWB map information and UWB signals output from four or more UWB devices.

In addition, according to another aspect of the disclosure, there is provided a pseudo-GNSS signal output method of outputting a pseudo-GNSS signal in a plurality of remote devices disposed in a tunnel. In addition, according to an embodiment, the pseudo-GNSS signal output method includes outputting a radio detection and ranging (RADAR) signal from a RADAR device of each of the plurality of remote devices, recognizing a location and velocity of a vehicle traveling in the tunnel by using the RADAR signal detected by the RADAR device, transmitting the recognized location and velocity of the vehicle to a main device disposed outside the tunnel, receiving pseudo-GNSS signal information from the main device, and generating and outputting a pseudo-GNSS signal through at least one pseudo-GNSS signal output device by using the pseudo-GNSS signal information.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a diagram illustrating a pseudo-global navigation satellite system (GNSS) signal output system according to an embodiment.

FIG. 2 is a diagram illustrating a configuration of a main device and a remote device according to an embodiment.

FIG. 3 is a flowchart of a pseudo-GNSS signal output method according to an embodiment.

FIG. 4 is a diagram illustrating an arrangement and connection structure of a main device and a remote device according to an embodiment.

FIG. 5 is a diagram illustrating a process of measuring an optical delay and generating pseudo-GNSS signal information by reflecting the optical delay, according to an embodiment.

FIG. 6A is a perspective view illustrating a state in which a cover of a remote device is opened, according to an embodiment; FIG. 6B illustrates the outer appearance of the front part of the remote device when the cover of the remote device is closed.

FIG. 7 is a diagram illustrating a state in which a pseudo-GNSS signal for each lane is output, according to an embodiment.

FIG. 8 is a diagram illustrating a state in which pseudo-GNSS signals are output forward and backward in a tunnel, according to an embodiment.

FIG. 9 is a block diagram illustrating a structure of a remote device according to an embodiment.

### DETAILED DESCRIPTION

Because the GNSS uses information received from satellites, there is a limitation in that it is difficult to determine a location of a receiver in GNSS shadow areas, such as underground facilities, in which there is an obstacle in the line of sight (LOS) with a satellite. Due to this, it is difficult to provide accurate location information when attempting to provide location information by using a GNSS indoors. For example, in the case of systems that involve providing location information indoors or underground or in tunnels, such as bus arrival time notification services or navigation guidance systems in underground facilities, the limitations of GNSS degrade the quality of public services useful to citizens. When buses are located in underground transfer centers or long tunnels, GNSS reception may be impossible, making it impossible to track the location of the bus, and the accuracy of bus location information and expected arrival time provided by expected arrival time services may decrease.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present specification clarifies the scope of the claims of the disclosure, and explains the principles of embodiments and discloses embodiments so that those of ordinary skill in the art may practice the embodiments. The disclosed embodiments may be implemented in various forms.

The same reference numerals denote the same elements throughout the specification. The present specification does not explain all elements of the embodiments, and general descriptions in the technical field to which the disclosure belongs or redundant descriptions between the embodiments are omitted. The term “part” or “portion” as used in the specification may be implemented in software or hardware. According to embodiments, a plurality of “parts” or “portions” may be implemented as a single unit or element, or one “part” or “portion” may include a plurality of units or elements. Hereinafter, the embodiments and the operating principles of the embodiments will be described with reference to the accompanying drawings.

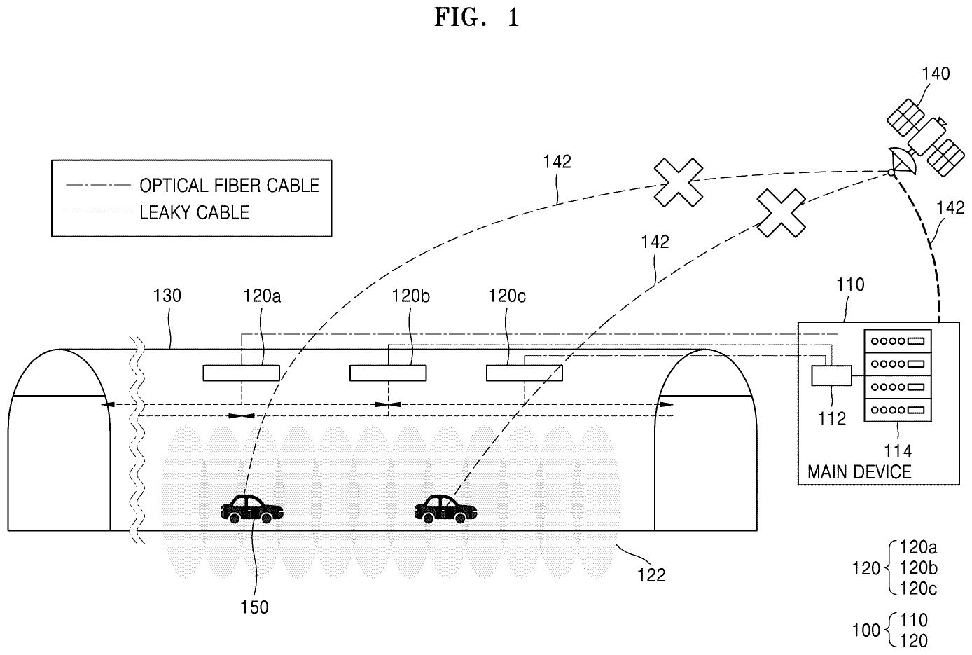

FIG. 1 is a diagram illustrating a pseudo-global navigation satellite system (GNSS) signal output system 100 according to an embodiment.

The pseudo-GNSS signal output system 100 according to embodiments may be installed in a GNSS shadow area 130 where satellite signals 142 from a satellite 140 are not transmitted and may generate and output pseudo-GNSS signals 122. Examples of the GNSS shadow area 130 may include tunnels, interiors of buildings, underground spaces, or the like. The GNSS shadow area 130 is an area where the satellite signals 142 are not transmitted due to obstacles, such as concrete or steel bars.

Because the satellite signals 142 are not transmitted to the GNSS shadow area 130, a client device 150 in the GNSS shadow area 130 is unable to receive a GNSS signal. Due to this, the client device 150 in the GNSS shadow area 130 is unable to receive the satellite signals 142 from the satellite 140. The pseudo-GNSS signal output system 100 according to embodiments may generate the pseudo-GNSS signal 122, as if the satellite 140 generates and outputs the signal in the GNSS shadow area 130, and may output the pseudo-GNSS signal 122 to the client device 150 in the GNSS shadow area 130. Because the pseudo-GNSS signal 122 is a signal generated in the same manner as the signal output from the satellite 140, the client device 150 may obtain location information by processing the pseudo-GNSS signal 122 in the same manner as the satellite signal 142 received from the outside of the GNSS shadow area 130. Therefore, according to embodiments, location information may be obtained from the pseudo-GNSS signal 122 by using a general-purpose GNSS module of the client device 150. That is, according to embodiments, the client device 150 does not need to change the device structure for processing the pseudo-GNSS signal 122.

Examples of the GNSS including the satellite 140 may include the United States' global positioning system (GPS), Russia's global navigation satellite system (GLONASS), the European Union's Galileo system, China's Beidou, Japan's quasi-zenith satellite system (QZSS), or India's Indian regional navigation satellite system (IRNSS). The pseudo-GNSS signal output system 100 may generate and output the pseudo-GNSS signal 122 corresponding to a target GNSS.

The pseudo-GNSS signal output system 100 according to an embodiment may include a main device 110 and a plurality of remote devices 120. The pseudo-GNSS signal output system 100 may be disposed inside and outside a tunnel. The inside of the tunnel may correspond to the GNSS shadow area 130. The main device 110 may be disposed inside or outside the tunnel. The plurality of remote devices 120 may be disposed inside the tunnel.

The main device 110 may be disposed at a location where the satellite signal 142 may be received from the satellite 140. The main device 110 may communicate with the plurality of remote devices 120. The main device 110 and the plurality of remote devices 120 may be connected to each other through an optical fiber cable. The main device 110 and the plurality of remote devices 120 may communicate with each other by using optical communication through the optical fiber cable.

The main device 110 may receive future GNSS navigation information from a server of the GNSS and generate pseudo-GNSS signal information used to generate the pseudo-GNSS signal 122 by using the future GNSS navigation information. The GNSS navigation information is information about a location at which at least one satellite 140 is to be positioned at a certain point in the future. The server may update the GNSS navigation information at intervals of several seconds, several minutes, several days, or several weeks. The main device 110 may receive the GNSS navigation information from the server at a cycle equal to the interval during which the GNSS navigation information is updated or at a cycle shorter than the update interval, and may update the stored GNSS navigation information. The main device 110 may receive the GNSS navigation information from the server during a certain future time period (e.g., 4 weeks) of at least one satellite 140. When there are 13 satellites 140, the main device 110 may receive the GNSS navigation information for each of the 13 satellites 140. According to an embodiment, there may be at least one server that provides the GNSS navigation information corresponding to each of the 13 satellites 140, and the main device 110 may receive the GNSS navigation information from each of the at least one server. The GNSS navigation information may be stored and transmitted in the form of, for example, a receiver independent exchange (RINEX) file.

The main device 110 may transmit the generated pseudo-GNSS signal information to the plurality of remote devices 120. The main device 110 may transmit the pseudo-GNSS signal information to the plurality of remote devices 120 at a certain cycle. The main device 110 may include an optical signal converter 112 and a signal generator 114. The optical signal converter 112 may convert a radio frequency (RF) signal generated by the signal generator 114 into an optical signal and transmit the optical signal through an optical fiber cable. The signal generator 114 may generate pseudo-GNSS signal information corresponding to the GNSS navigation information and output the pseudo-GNSS signal information to the optical signal converter 112. According to an embodiment, the main device 110 may generate and output pseudo-GNSS signal information for each of the plurality of remote devices 120. For example, the main device 110 may generate first pseudo-GNSS signal information for a first remote device 120a and transmit the first pseudo-GNSS signal information to the first remote device 120a. In addition, the main device 110 may generate second pseudo-GNSS signal information for a second remote device 120b and transmit the second pseudo-GNSS signal information to the second remote device 120b. In addition, the main device 110 may generate third pseudo-GNSS signal information for a third remote device 120c and transmit the third pseudo-GNSS signal information to the third remote device 120c.

According to an embodiment, the main device 110 may measure a Doppler shift from the satellite signal 142 received from the satellite 140 in real time and reflect the measured Doppler shift into the GNSS navigation information.

The plurality of remote devices 120 may be disposed at different locations in the tunnel. The plurality of remote devices 120 may receive pseudo-GNSS signal information from the main device 110. The plurality of remote devices 120 may generate and output the pseudo-GNSS signals 122 by using the pseudo-GNSS signal information.

According to an embodiment, each of the remote devices 120 may include a GNSS antenna and may output the pseudo-GNSS signal 122 through the GNSS antenna. The GNSS antenna is a directional antenna that may adjust a direction and an output angle range of a signal. According to an embodiment, a different pseudo-GNSS signal 122 may be output for each lane by using a directional GNSS antenna. The signals output from the GNSS antennas for each lane may have different signal characteristics (e.g., frequency) or different pieces of additional information.

In addition, according to an embodiment, the plurality of remote devices 120 may output the pseudo-GNSS signals 122 through leaky cables. The leaky cables may be installed to transmit signals in certain directions from the first, second, and third remote devices 120a, 120b, and 120c. One end of each of the leaky cables may be connected to an output terminal of each of the first to third remote devices 120a, 120b, and 120c, and the other end thereof may be connected to a certain signal transmission terminal. The leaky cable may be disposed to correspond to a signal transmission direction of the pseudo-GNSS signal 122. For example, two leaky cables may be connected to one remote device 120a, 120b, or 120c, and the two leaky cables may be disposed to transmit the pseudo-GNSS signals 122 in opposite directions from one remote device 120a, 120b, or 120c. In addition, the leaky cables may be installed individually for each lane. The leaky cables in each lane may have different signal characteristics (e.g. frequency) or different pieces of additional information.

The leaky cable may be referred to as a leaky coaxial cable and may be a cable that is processed so that a slot for signal leakage is formed in an outer conductor of a coaxial cable, and thus, the cable itself acts as a GNSS antenna. The leaky cable may output a pseudo-GNSS signal by artificially processing the outer conductor of the coaxial cable to cause electromagnetic waves to flow so that a signal leaks around the leaky cable. The leaky cable may be implemented to optimize signal transmission characteristics in a GNSS L1 frequency range.

The leaky cable may have the characteristic in which signal intensity decreases linearly while a signal is transmitted. Therefore, the intensity of the pseudo-GNSS signal 122 output from the remote device 120 may decrease linearly while the pseudo-GNSS signal 122 is transmitted along the leaky cable. According to an embodiment, the leaky cables are disposed in parallel to transmit the pseudo-GNSS signals 122 in opposite directions, and thus, the pseudo-GNSS signal 122 of a certain level or higher may be received at any location. Therefore, according to an embodiment, there is an effect of maintaining a signal-to-noise ratio (SNR) of a certain level or higher throughout the GNSS shadow area 102 by using the leaky cable.

The tunnel environment is extremely harsh, with a lot of dust and drastic temperature changes. A temperature change that is very similar to that of the external environment occurs in the tunnel. Therefore, even when an industrial personal computer (PC) is used, it may be impossible to operate the device 24 hours a day, 365 days a year inside the tunnel. In addition, the maintenance of the system is difficult because there is a maintenance point at each point. According to an embodiment, a processing unit requiring a plurality of operations may be disposed in the main device 110 provided in a separate space inside or outside the tunnel, and the remote device 120 including only a minimum of hardware may be disposed inside the tunnel. Accordingly, the maintenance of the system may be facilitated while the durability of the system is improved.

In addition, according to an embodiment, the remote device 120 may include a radio detection and ranging (RADAR) sensor. The remote device 120 may use the RADAR sensor to identify a vehicle traveling in a tunnel and detect the velocity of the vehicle. The remote device 120 may transmit, to the main device 110, vehicle information and vehicle velocity information detected by using the RADAR sensor. The main device 110 may determine the attributes of the pseudo-GNSS signal output from the remote device 120 by using the vehicle information and the vehicle velocity information obtained from the remote device 120. With this configuration, there is an effect of improving the vehicle's reception rate of the pseudo-GNSS signal because the pseudo-GNSS signal output system 100 according to an embodiment outputs the pseudo-GNSS signal by reflecting the traveling state of the vehicle.

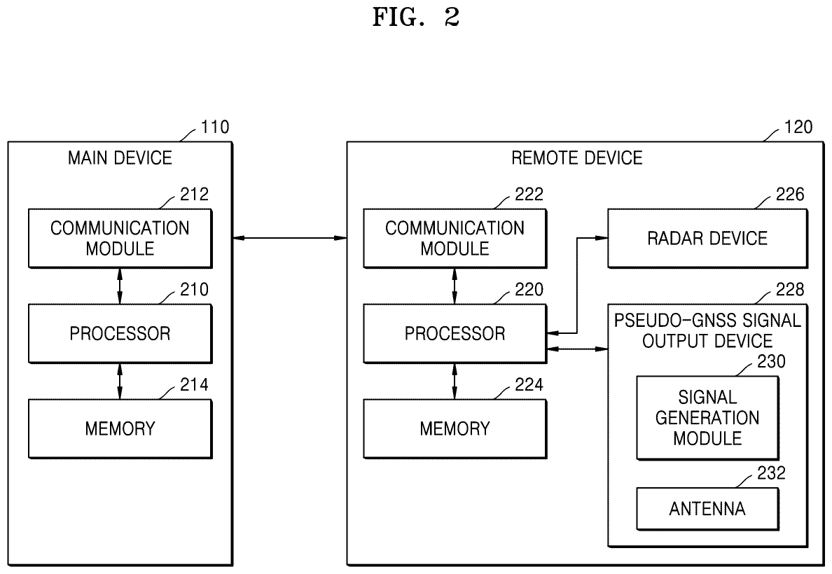

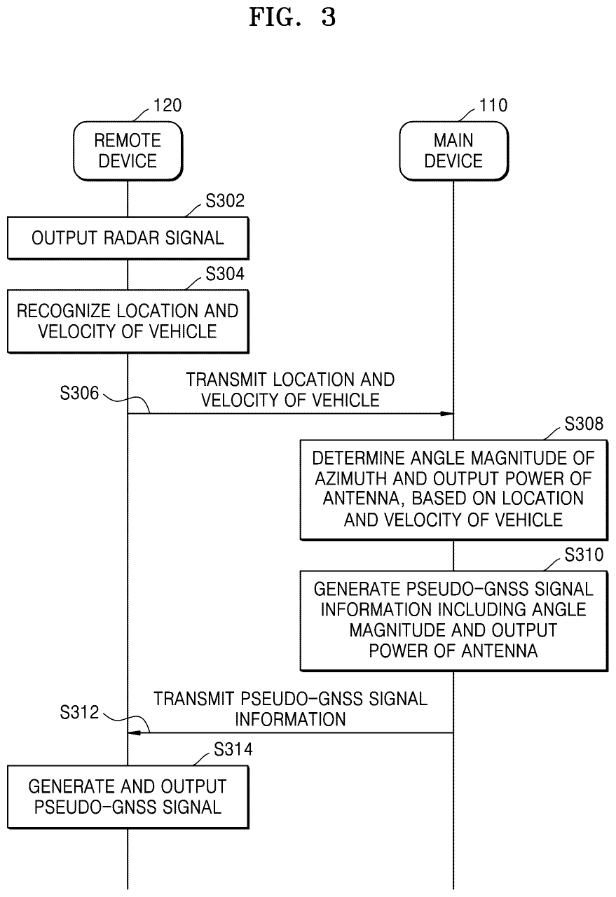

FIG. 2 is a diagram illustrating the configuration of the main device 110 and the remote device 120 according to an embodiment.

According to an embodiment, the main device 110 may include a processor 210, a communication module 212, and a memory 214.

The main device 110 may be disposed in a certain space outside or inside the tunnel. The main device 110 may communicate with the outside and may be disposed at a location where the satellite signal 142 may be received.

The communication module 212 may communicate with an external device in a wired or wireless manner. The communication module 212 may communicate with the server and the plurality of remote devices 120. The communication module 212 may communicate with the server and the plurality of remote devices 120 in different communication schemes. The communication module 212 may perform short-range wireless communication and may use, for example, Bluetooth, Bluetooth Low Energy (BLE), near field communication (NFC), wireless local area network (WLAN) (Wireless-Fidelity (Wi-Fi™)), Zigbee, Infrared Data Association (IrDA) communication, Wi-Fi Direct (WFD), Ultra-Wideband (UWB), Ant+ communication, etc. In another example, the communication module 212 may use mobile communication and may transmit and receive wireless signals to and from at least one of a base station, an external terminal, or a server on a mobile communication network.

The communication module 212 may communicate with the remote device 120. According to an embodiment, the communication module 212 may perform optical communication with the remote device 120 through an optical fiber cable or a coaxial cable. The communication module 212 may include a converter that converts a digital signal generated by the processor 210 into an optical signal or converts a signal received through optical communication into a digital signal. For example, the communication module 212 may include an RF to optic converter.

In addition, the communication module 212 may communicate with the server. The communication module 212 may receive future GNSS navigation information from the server. The communication module 212 may receive GNSS navigation information from the server at a certain cycle.

The processor 210 may control the overall operation of the main device 110. The processor 210 may include one or more processors.

The processor 210 may control the communication module 212 to receive the GNSS navigation information from the server. The processor 210 may request the GNSS navigation information from the server at certain intervals and receive GNSS navigation information from the server. The processor 210 may receive the GNSS navigation information from the server at variously defined intervals, for example, once a week or once a month. The processor 210 may connect to a plurality of servers to receive the GNSS navigation information for the plurality of satellites 140. For example, the processor 210 may receive GNSS navigation information for a first satellite from a first server and may receive GNSS navigation information for a second satellite from a second server. The timing and cycle of receiving the GNSS navigation information may vary from server to server. For example, the GNSS navigation information for the first satellite may be received every Monday at 9:00 AM for one week, and the GNSS navigation information for the second satellite may be received every 10 days at 10:00 AM for the first day.

According to an embodiment, the processor 210 may generate the pseudo-GNSS signal information by using the GNSS navigation information received from the server. The processor 210 may generate the pseudo-GNSS signal information for each of the plurality of remote devices 120. In addition, the processor 210 may generate the pseudo-GNSS signal information for each of the plurality of satellites. The processor 210 may use the GNSS navigation information to generate the pseudo-GNSS signal information by reflecting the location of each of the remote devices 120. The processor 210 may transmit the generated pseudo-GNSS signal information to each of the remote devices 120 through the communication module 212.

The processor 210 may generate in-phase and quadrature (IQ) phase data by using the GNSS navigation information. The IQ phase data is data that includes information about amplitudes and phases of an in-phase carrier and a quadrature phase carrier used for quadrature amplitude modulation (QAM). The processor 210 may use the GNSS navigation information to generate the IQ phase data corresponding to a current location and a current time and generate pseudo-GNSS signal information including the IQ phase data. The processor 210 may generate the IQ phase data synchronized with the current time.

According to an embodiment, the main device 110 may receive, from the remote device 120, location information and velocity information of a vehicle in a tunnel. The processor 210 may generate the pseudo-GNSS signal information based on the location information and the velocity information of the vehicle received from the remote device 120. The processor 210 may adjust the direction or angle range of the pseudo-GNSS signal output from the remote device 120, based on the location information and the velocity information of the vehicle. The processor 210 may generate the pseudo-GNSS signal information including information about the direction or angle range of the pseudo-GNSS signal and transmit the pseudo-GNSS signal information to the remote device 120.

The memory 214 may store information, signals, data, instructions, or programs necessary for the operation of the main device 110. The memory 214 may include one of volatile memory or non-volatile memory, or any combination thereof. The memory 214 may include, for example, at least one type of storage medium selected from among flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc. In addition, the memory 214 may correspond to a web storage or a cloud server that performs a storage function on the Internet.

The memory 214 may store information about the server that provides the GNSS navigation information for each satellite, the update cycle, and the update time. The processor 210 may obtain the GNSS navigation information from the server by using the information about the server that provides the GNSS navigation information for each satellite, the update cycle, and the update time, which are stored in the memory 214. The information about the server that provides the GNSS navigation information may include, for example, a server name, a server access address, authentication information for connecting to the server, a protocol for communicating with the server, and a server operating entity.

The processor 210 may store and manage, in the memory 214, the GNSS navigation information received through the communication module 212. The processor 210 may store and manage, in the memory 214, information, such as the last update time of the GNSS navigation information stored in the memory 214, information about how long the GNSS navigation information is held, the source of the GNSS navigation information, and the type and number of satellites that may currently use the GNSS navigation information from the memory 214. The processor 210 may store and update the GNSS navigation information management information in the memory 214 whenever the GNSS navigation information received from the server is updated.

The processor 210 may store and manage, in the memory 214, information about the plurality of remote devices 120 and information about connection paths. In addition, the processor 210 may receive, from the plurality of remote devices 120, state information of the plurality of remote devices 120 and manage the states of the plurality of remote devices 120. The processor 210 may periodically receive the state information of the plurality of remote devices 120, or may receive the state information from the plurality of remote devices 120 when an event such as an error occurs in the plurality of remote devices 120. The state information of the plurality of remote devices 120 may include, for example, power on/off states of the remote devices 120 and operation modes of the remote devices 120 (e.g., a normal mode, a GNSS navigation information update mode, an abnormal mode, etc.).

The plurality of remote devices 120 may have pieces of identification information, respectively. The main device 110 may store and manage identification information, location information, etc. of the plurality of remote devices 120.

The remote device 120 may include a processor 220, a communication module 222, a memory 224, a RADAR device 226, and a pseudo-GNSS signal output device 228. Each of the plurality of remote devices 120 may correspond to the structure of the remote device 120 illustrated in FIG. 2. The plurality of remote devices 120 may be disposed at a first interval in the tunnel. The intervals between the plurality of remote devices 120 may be set to be constant or individually different from each other. For example, the plurality of remote devices 120 may be disposed at the first interval in a straight section of a lane within the tunnel and may be disposed at an interval shorter than the first interval in a curved section of a lane within the tunnel.

The communication module 222 may communicate with an external device in a wired or wireless manner. The communication module 222 may communicate with the main device 110. According to an embodiment, the communication module 222 may communicate with another remote device 120.

According to an embodiment, the communication module 222 may perform short-range wireless communication and may use, for example, Bluetooth, BLE, NFC, WLAN (Wi-Fi™), Zigbee, IrDA communication, WFD, UWB, Ant+ communication, etc. In another example, the communication module 222 may use mobile communication and may transmit and receive wireless signals to and from at least one of a base station, an external terminal, or a server on a mobile communication network.

The communication module 222 may communicate with the main device 110. According to an embodiment, the communication module 222 may perform optical communication with the main device 110 through an optical fiber cable or a coaxial cable. The communication module 222 may include a converter that converts a digital signal generated by the processor 220 into an optical signal or converts a signal received through optical communication into a digital signal. For example, the communication module 222 may include an optic to RF converter.

In addition, according to an embodiment, the communication module 222 may communicate with a vehicle traveling on a lane in a tunnel. The communication module 222 may communicate with a vehicle in a tunnel by using short-range wireless communication, such as Bluetooth, BLE, NFC, WLAN, Zigbee, IrDA communication, WFD, UWB, Ant+ communication, etc.

The processor 220 may control the overall operation of the remote device 120. The processor 220 may include one or more processors.

The processor 220 may receive pseudo-GNSS signal information from the main device 110 through the communication module 222. The processor 220 may receive the pseudo-GNSS signal information periodically or in real time. The processor 220 may store the received pseudo-GNSS signal information in the memory 224 or transmit the received pseudo-GNSS signal information to the pseudo-GNSS signal output device 228.

The memory 224 may store information, signals, data, instructions, or programs necessary for the operation of the remote device 120. The memory 224 may include one of volatile memory or non-volatile memory, or any combination thereof. The memory 224 may include, for example, at least one type of storage medium selected from among flash memory-type memory, hard disk-type memory, multimedia card micro-type memory, card-type memory (e.g., SD or XD memory), RAM, SRAM, ROM, EEPROM, PROM, magnetic memory, magnetic disc, and optical disc. In addition, the memory 224 may correspond to a web storage or a cloud server that performs a storage function on the Internet.

According to an embodiment, the memory 224 may store the pseudo-GNSS signal information received from the main device 110.

The RADAR device 226 may detect a vehicle traveling in a tunnel by using a radar signal. The RADAR device 226 may include a RADAR sensor. The RADAR sensor may generate electromagnetic waves, output the electromagnetic waves toward an object, and detect the distance to the object and the direction of the object through the returning electromagnetic waves. The RADAR sensor may be a type of time of flight (ToF) sensor. The RADAR device 226 may transmit a vehicle detection signal detected by the RADAR signal to the processor 220.

The processor 220 may receive the vehicle detection signal from the RADAR device 226 and identify the location and velocity of the vehicle. The processor 220 may identify the location of the vehicle over time by using the vehicle detection signal. In addition, the processor 220 may calculate the velocity of each vehicle, based on the location of the vehicle over time. The processor 220 may transmit location information and velocity information of the identified vehicle to the main device 110 through the communication module 222.

The pseudo-GNSS signal output device 228 may generate and output a pseudo-GNSS signal by using the pseudo-GNSS signal information received from the main device 110. According to an embodiment, the pseudo-GNSS signal output device 228 may include a signal generation module 230 and a GNSS antenna 232.

The signal generation module 230 may generate the pseudo-GNSS signal from the pseudo-GNSS signal information. The pseudo-GNSS signal information may include IQ phase data. The signal generation module 230 may generate the pseudo-GNSS signal by modulating a GNSS L1 carrier signal based on the IQ phase data. An L1 frequency of an L1 carrier may be determined as 1575.42 MHz for global positioning system (GPS), 1602.0 to 1615.5 MHz for global navigation satellite system (GLONASS), 1561.1 MHz for Beidou, 1575.42 MHz for quasi-zenith satellite system (QZSS), and 1176.45 MHz for Indian regional navigation satellite system (IRNSS). The pseudo-GNSS signal output device 228 may be implemented in various forms, such as an analog circuit that generates and processes an analog signal, a microcontroller, etc. The signal generation module 230 may be implemented in the form of a software-defined radio (SDR) device having an RF transceiver such as, for example, a field programmable gate array (FPGA)-based transceiver (BladeRF, etc.), an advanced reduced instruction set computer (RISC) machine (ARM) core-based transceiver (HackRF, etc.), an Intel core-based transceiver, or an advanced micro devices (AMD) core-based transceiver. The signal generation module 230 may output the generated pseudo-GNSS signal to the GNSS antenna 232.

The signal generation module 230 may generate the pseudo-GNSS signal synchronized with the real-time satellite signal output from the satellite 140. The main device 110 may measure the optical delay to the plurality of remote devices 120. According to an embodiment, the main device 110 may measure the optical delay by periodically transmitting a delay measurement message to the remote device 120 and receiving a response message to the delay measurement message from the remote device 120. The main device 110 may transmit, to the remote device 120, the pseudo-GNSS signal information in which the optical delay value is reflected so as to output the pseudo-GNSS signal synchronized with the real-time satellite signal, based on the optical delay value of each of the remote devices 120. For example, the main device 110 may insert output timing information of the pseudo-GNSS signal into the pseudo-GNSS signal information. In addition, for example, the main device 110 may stream the pseudo-GNSS signal information to the remote device 120 by reflecting the optical delay value.

According to an embodiment, the signal generation module 230 may generate a coarse/acquisition (C/A) code by reflecting the optical delay. The signal generation module 230 may define the location of each of the remote devices 120 by reflecting the optical delay. The signal generation module 230 may generate the C/A code corresponding to the location of each of the remote devices 120 defined by the optical delay. The signal generation module 230 may generate IQ data by using the generated C/A code.

The signal generation module 230 may generate the pseudo-GNSS signal for each satellite. The pseudo-GNSS signal information may include pieces of pseudo-GNSS signal information for the plurality of satellites.

The GNSS antenna 232 may output the pseudo-GNSS signal. The GNSS antenna 232 may include a plurality of GNSS antennas that output signals independently of each other. The plurality of GNSS antennas may output pseudo-GNSS signals respectively corresponding to different satellites.

The GNSS antenna 232 may be implemented as a directional antenna with high directivity. In addition, the GNSS antenna 232 may be implemented as an antenna that may adjust an angle range of an azimuth of an output signal. For example, the GNSS antenna 232 may have a form in which a reflection plate is attached to a back side thereof. The GNSS antenna 232 may include, for example, a collinear antenna.

FIG. 3 is a flowchart of a pseudo-GNSS signal output method according to an embodiment.

The pseudo-GNSS signal output method according to an embodiment may be performed by the pseudo-GNSS signal output system 100 including the main device 110 and the plurality of remote devices 120. The disclosure is described focusing on an embodiment where the pseudo-GNSS signal output system 100 performs the pseudo-GNSS signal output method, but the embodiment is not limited thereto.

Referring to FIG. 3, in operation S302, the remote device 120 may output a RADAR signal. The remote device 120 may output the RADAR signal toward the road in the tunnel and transmit or output the RADAR signal to the traveling vehicle. Each of the plurality of remote devices 120 may output the RADAR signal.

In operation S304, the remote device 120 may detect a RADAR signal reflected from the vehicle and recognize the location and velocity of the vehicle by using the detected RADAR signal. The remote device 120 may identify the location of the vehicle by using the detected RADAR signal. In addition, the remote device 120 may detect the velocity of each vehicle by calculating the change in the position of the vehicle over time.

According to an embodiment, the remote device 120 may detect lane information when detecting the location of the vehicle. The remote device 120 may identify the lane of each vehicle, based on coordinates of the vehicle. The location information of the vehicle may include lane information. In addition, the remote device 120 may calculate an average velocity for each lane. The remote device 120 may calculate the velocity for each lane by using the velocity of the vehicle detected for each lane.

In operation S306, the remote device 120 may transmit the detected location and velocity of the vehicle to the main device 110. According to an embodiment, the remote device 120 may transmit the location and velocity of the vehicle to the main device 110 through optical communication by using an optical fiber cable.

In operation S308, the main device 110 may determine the angle magnitude of the azimuth and the output power of the GNSS antenna 232 that is to output a pseudo-GNSS signal from the remote device 120, based on the location and velocity of the vehicle received from the remote device 120. The main device 110 may determine the angle magnitude of the azimuth and the output power of the GNSS antenna 232 for each of the plurality of remote devices 120.

The main device 110 may determine the angle magnitude of the azimuth, based on the velocity of the vehicle received from the remote device 120. The main device 110 may set the angle magnitude of the azimuth to increase as the velocity of the vehicle increases. A sufficient antenna exposure time (dwell time) may be required to receive the GNSS signal from the vehicle. When the velocity of the vehicle is high, the azimuth of the GNSS antenna 232 has to increase so as to have a sufficient antenna exposure time. The main device 110 may ensure a sufficient antenna exposure time by adjusting the azimuth of the GNSS antenna 232 according to the velocity of the vehicle so that each vehicle has a sufficient antenna exposure time. The angle magnitude of the azimuth of the GNSS antenna 232 may increase as the velocity of the vehicle increases.

In addition, according to an embodiment, the main device 110 may adjust the output power of the GNSS antenna 232 according to the velocity of the vehicle. The main device 110 may increase the output power of the GNSS antenna 232 as the angle magnitude of the azimuth increases. As the angle magnitude of the azimuth increases, the output range of the output signal may widen, and thus, higher output power may be required.

According to an embodiment, the main device 110 may store a lookup table that stores the angle magnitude of the azimuth and the output power value of the GNSS antenna according to the velocity of the vehicle. The main device 110 may determine the angle magnitude of the azimuth and the output power value of the GNSS antenna according to the velocity of the vehicle by using the lookup table.

The main device 110 may receive vehicle location and velocity information from the remote device 120 in real time or periodically. The main device 110 may adjust the angle magnitude of the azimuth and the output power of the GNSS antenna of each of the remote devices 120, based on the vehicle location and velocity information in real time or periodically.

In addition, in operation S310, the main device 110 may generate pseudo-GNSS signal information. The main device 110 may generate the pseudo-GNSS signal information by using GNSS navigation information. The main device 110 may generate IQ data based on C/A code of the GNSS navigation information. The main device 110 may be synchronized with a satellite signal and may generate IQ data in which the optical delay for each of the remote devices 120 is reflected. The main device 110 may generate pseudo-GNSS signal information including the IQ data and GNSS antenna output information. The GNSS antenna output information may include the angle magnitude of the azimuth and the output power of the GNSS antenna. The pseudo-GNSS signal information may be generated in real time or periodically over time.

According to an embodiment, the main device 110 may generate IQ data in the form of quadratic phase-shift keying (QPSK). The main device 110 may transmit the C/A code to a Q phase of the IQ data and insert the C/A code and arbitrary precise (P) code into an I phase. At this time, the C/A code may be a valid value and the P code may be invalid P code as pseudo-P code.

When the pseudo-GNSS signal is generated, a binary phase-shift keying (BPSK) signal may be generated and output based on the open C/A code. However, in this case, older GNSS signal receivers or precision receivers of the pre-2017 type have no problem receiving the pseudo-GNSS signals, but the latest GPS receivers have problems receiving the pseudo-GPS signals. The older GNSS signal receivers use a method of extracting GNSS signals in response to RF transmitted in the form of BPSK. However, due to the high performance of RF receivers, the latest GNSS receivers distinguish IQ signals after reception and then decode only a Q signal by using code division multiple access (CDMA). In general, signals transmitted in the form of BPSK have to be received in BPSK so as to achieve proper performance, and signals transmitted in the form of QPSK have to be received in the form of QPSK so as to achieve proper performance. For each satellite, it is unclear whether a plurality of signals are transmitted in the form of BPSK or combined into the form of QPSK, and the corresponding information is confidential, and thus, is not disclosed.

According to an embodiment, when the pseudo-GNSS signal is transmitted, the pseudo-GNSS signal may be output in the form of QPSK having an IQ format in which the C/A code is transmitted to the Q phase and the C/A code and the arbitrary P code are transmitted to the I phase. To this end, the main device 110 may generate IQ data in the form of QPSK and the remote device 120 may generate and output the pseudo-GNSS signal in the form of QPSK. Even when the vehicle normally receives the arbitrary P-code, the general receiver is unable to decode the P-code. Accordingly, malfunction or misrecognition of location due to the arbitrary P-code does not occur. However, because the pseudo-GNSS signal in the format of QPSK was transmitted, an effect of increasing the decoding speed of the C/A code of the Q phase in the receiver of the vehicle occurred. For example, when a GPS L1 signal is transmitted, the decoding speed of the GPS signal is faster when both the I phase and the Q phase are transmitted to the QPSK format signal than when the C/A code is transmitted in the Q phase to the BPSK format signal. Therefore, according to an embodiment, because the IQ data in the form of QPSK is generated and the pseudo-GNSS signal is generated and output, there is an effect of increasing the success rate of receiving the pseudo-GNSS signal in the vehicle and improving the decoding speed.

In operation S312, the main device 110 may transmit the pseudo-GNSS signal information to the remote device 120. The main device 110 may convert the pseudo-GNSS signal information into an optical signal and transmit the optical signal to the plurality of remote devices 120 through an optical cable.

In operation S314, the remote device 120 may generate the pseudo-GNSS signal based on the pseudo-GNSS signal information received from the main device 110. The remote device 120 may generate the pseudo-GNSS signal by using the IQ data included in the pseudo-GNSS signal information. In addition, the remote device 120 may control the angle magnitude of the azimuth and the output power of the GNSS antenna 232 by using the GNSS antenna output information included in the pseudo-GNSS signal information.

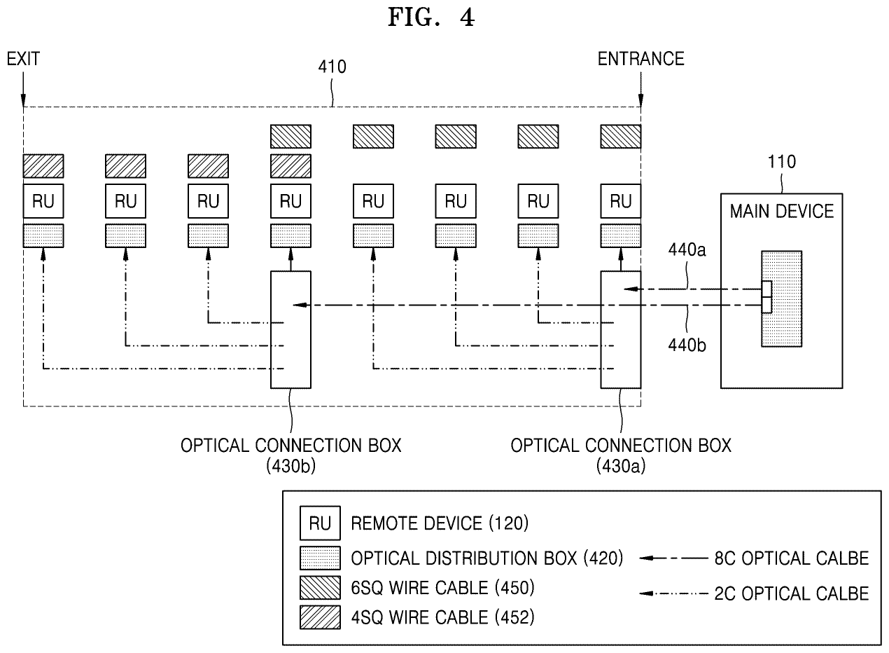

FIG. 4 is a diagram illustrating an arrangement and connection structure of a main device and a remote device according to an embodiment. FIG. 4 illustrates an embodiment in which one main device 110 and eight remote devices 120 are disposed. However, embodiments are not limited thereto, and the number of remote devices 120 may be variously determined depending on an embodiment.

According to an embodiment, the main device 110 may be disposed on an entrance side of a tunnel 410. The remote devices 120 may be disposed at regular intervals from the entrance of the tunnel 410. The plurality of remote devices 120 may be disposed at an interval of, for example, 150 m.

Each of the main device 110 and the remote devices 120 may include an optical distribution box 420. The optical distribution box 420 may be connected to an optical cable and may transmit a signal output from the device to the optical cable or may transmit a signal transmitted through the optical cable to the device. The optical distribution box 420 may terminate the connected optical cable at a connector and connect the connected optical cable to an actual device. Each of the main device 110 and the remote devices 120 may be connected to the optical cable through the optical distribution box 420. The optical distribution box 420 of the main device 110 may be connected to two 8-core optical cables (optical cables 8C). The 8-core optical cable may include four strands of 2-core optical cables.

An 8-core optical cable 440a connected to a first terminal of the optical distribution box 420 of the main device 110 may be connected to a first optical connection box 430a. An 8-core optical cable 440b connected to a second terminal of the optical distribution box 420 may be connected to a second optical connection box 430b. When the 8-core optical cables are input to the first optical connection box 430a and the second optical connection box 430b, the 8-core optical cables may be distributed into four strands of 2-core optical cables and the respective strands may be connected to each other.

The four strands of the 2-core optical cables distributed from the first optical connection box 430a may be connected to four remote devices 120, that is, the first to fourth remote devices from the entrance. The four strands of the 2-core optical cables distributed from the second optical connection box 430b may be connected to four remote devices 120, that is, the fifth to eighth remote devices from the entrance. The 2-core optical cable may be connected to the optical distribution box 420 of the remote device 120.

The pseudo-GNSS signal output system 100 may include a wire cable that supplies power to the plurality of remote devices 120. According to an embodiment, a first wire cable 450 may be connected to five remote devices 120, that is, the first to fifth remote devices from the entrance. In addition, a second wire cable 452 may be connected to four remote devices 120, that is, the fifth to eighth remote devices from the entrance. The first wire cable 450 may be supplied with power from a power source outside the tunnel 410. The second wire cable 452 may be supplied with power transmitted from the fifth remote device 120 through the first wire cable 450. The first wire cable 450 may be a cable having a larger allowable current than the second wire cable 452. For example, the first wire cable 450 may be a 6 SQ wire cable and the second wire cable 452 may be a 4 SQ wire cable.

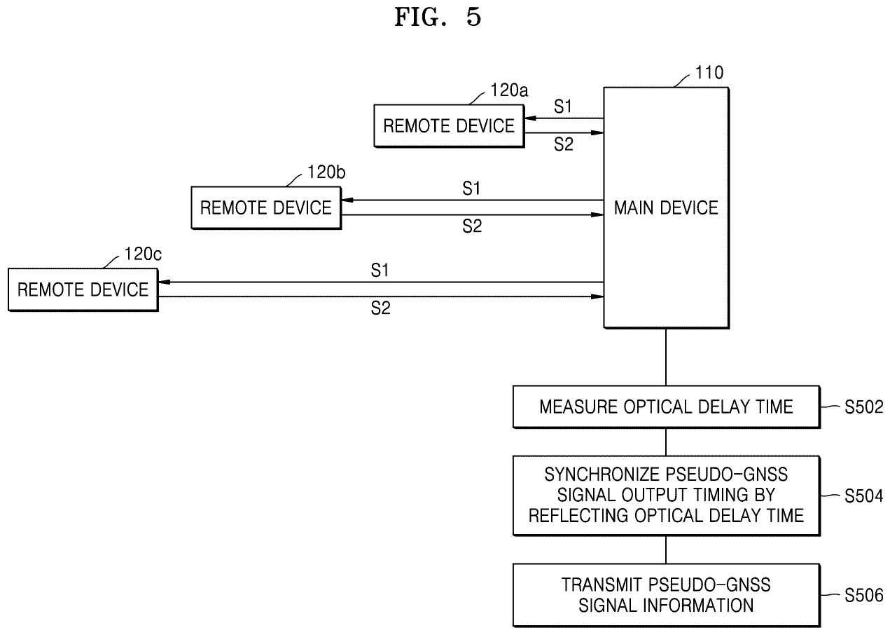

FIG. 5 is a diagram illustrating a process of measuring an optical delay and generating pseudo-GNSS signal information by reflecting the optical delay, according to an embodiment.

According to an embodiment, in operation S502, the main device 110 may periodically measure an optical delay time of each of remote devices 120a, 120b, and 120c. The main device 110 may transmit a delay measurement message S1 to each of the remote devices 120a, 120b, and 120c. The main device 110 may transmit the delay measurement message S1 to the plurality of remote devices 120a, 120b, and 120c simultaneously or sequentially. The main device 110 may receive a response message S2 to the delay measurement message S1 from the plurality of remote devices 120a, 120b, and 120c. The main device 110 may measure the optical delay time by measuring the delay time between the delay measurement message S1 and the response message S2. The main device 110 may measure the optical delay time of each of the remote devices 120a, 120b, and 120c, based on the response message S2 of each of the remote devices 120a, 120b, and 120c.

In operation S504, the main device 110 may synchronize the pseudo-GNSS signal output timing for each of the remote devices 120a, 120b, and 120c by reflecting the optical delay time. The main device 110 may determine the timing to transmit the pseudo-GNSS signal information to each of the remote devices 120a, 120b, and 120c by reflecting the optical delay time.

According to an embodiment, the optical delay time may correspond to a delay time when each of the remote devices 120a, 120b, and 120c generates and outputs the pseudo-GNSS signal from the pseudo-GNSS signal information and a delay time in which the time for transmitting the pseudo-GNSS signal information to each of the remote devices 120a, 120b, and 120c through an optical cable is reflected.

In operation S506, the main device 110 may generate the pseudo-GNSS signal information of which the pseudo-GNSS signal output timing is synchronized by reflecting the optical delay time and may transmit the pseudo-GNSS signal information to each of the remote devices 120a, 120b, and 120c. The main device 110 may transmit the pseudo-GNSS signal information to each of the remote devices 120a, 120b, and 120c at a timing earlier by the optical delay time so that each of the remote devices 120a, 120b, and 120c outputs the pseudo-GNSS signal in synchronization with a satellite signal. According to an embodiment, the main device 110 may stream the pseudo-GNSS signal information to each of the remote devices 120a, 120b, and 120c and the main device 110 may stream the pseudo-GNSS signal information to each of the remote devices 120a, 120b, and 120c at a timing earlier by the optical delay time.

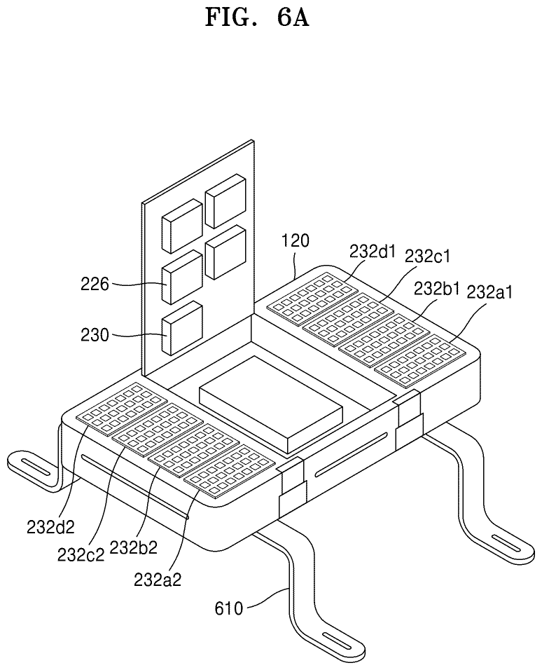

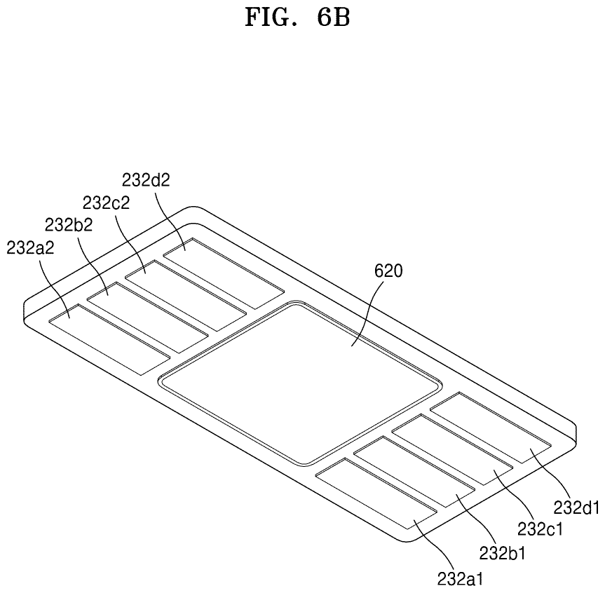

FIG. 6A is a perspective view illustrating a state in which a cover of the remote device 120 is opened, according to an embodiment. FIG. 6B illustrates the outer appearance of the front part of the remote device 120 when the cover of the remote device 120 is closed.

According to an embodiment, the remote device 120 may include a fixing member 610 fixed to the wall or ceiling of the tunnel 410. The fixing member 610 may be coupled to a housing of the remote device 120 and may have a structure that may be fixed to the wall or the ceiling of the tunnel 410 by a fixing means, such as a screw or a nail.

The remote device 120 may include a RADAR antenna 620 and a plurality of GNSS antennas 232a1, 232a2, 232b1, 232b2, 232c1, 232c2, 232d1, and 232d2 at the front part facing the ground direction of the lane from the upper part of the tunnel 410. The plurality of GNSS antennas 232a1, 232a2, 232b1, 232b2, 232c1, 232c2, 232d1, and 232d2 may independently output signals. A circuit part and a signal generation module 230 of the RADAR device 226 may be provided inside the housing of the remote device 120.

The RADAR antenna 620 may output a RADAR signal in the direction of the lane and detect a RADAR signal reflected from the vehicle. The RADAR device 226 may process the RADAR signal detected by the RADAR antenna 620 and transmit the processed RADAR signal to the processor 210.

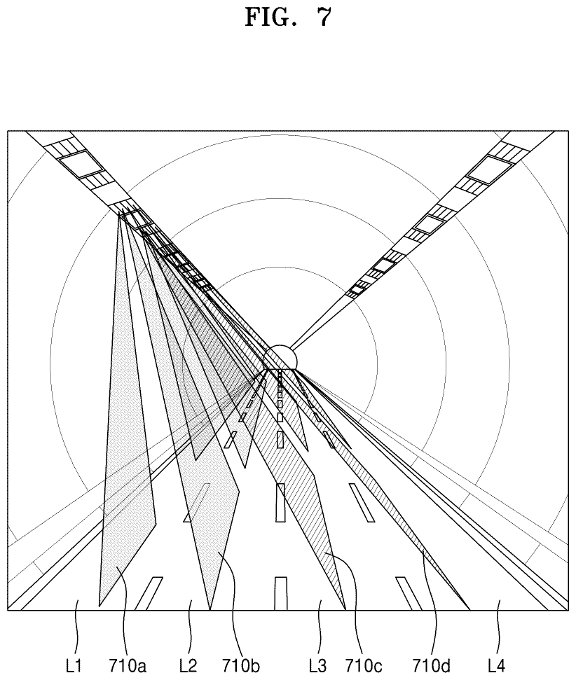

FIG. 7 is a diagram illustrating a state in which the pseudo-GNSS signal for each lane is output, according to an embodiment.

The plurality of GNSS antennas 232a1, 232a2, 232b1, 232b2, 232c1, 232c2, 232d1, and 232d2 may output pseudo-GNSS signals for different lanes. For example, the GNSS antennas 232a1 and 232a2 may output a pseudo-GNSS signal 710a for a first lane L1. The GNSS antennas 232b1 and 232b2 may output a pseudo-GNSS signal 710b for a second lane L2. The GNSS antennas 232c1 and 232c2 may output a pseudo-GNSS signal 710c for a third lane L3. The GNSS antennas 232d1 and 232d2 may output a pseudo-GNSS signal 710d for a fourth lane L4.

Because the plurality of GNSS antennas 232a1, 232a2, 232b1, 232b2, 232c1, 232c2, 232d1, and 232d2 have directivity, the plurality of GNSS antennas 232a1, 232a2, 232b1, 232b2, 232c1, 232c2, 232d1, and 232d2 may independently output pseudo-GNSS signals for the targeted lanes. Accordingly, the angle magnitude of the azimuth and the output power of the pseudo-GNSS signals for each lane may be individually controlled. Due to this, the pseudo-GNSS signal output system 100 may individually adjust the angle magnitude of the azimuth and the output power of the pseudo-GNSS signal according to the velocity of the vehicle for each lane. Accordingly, there is an effect of increasing the success rate of receiving the pseudo-GNSS signal while increasing energy efficiency.

According to an embodiment, the pseudo-GNSS signal may include lane information. For example, the pseudo-GNSS signal may include lane information in header information. The pseudo-GNSS signal output to each lane may include lane information corresponding to the corresponding lane. According to an embodiment, the remote device 120 may generate the pseudo-GNSS signal corresponding to each lane and insert the lane information into each pseudo-GNSS signal.

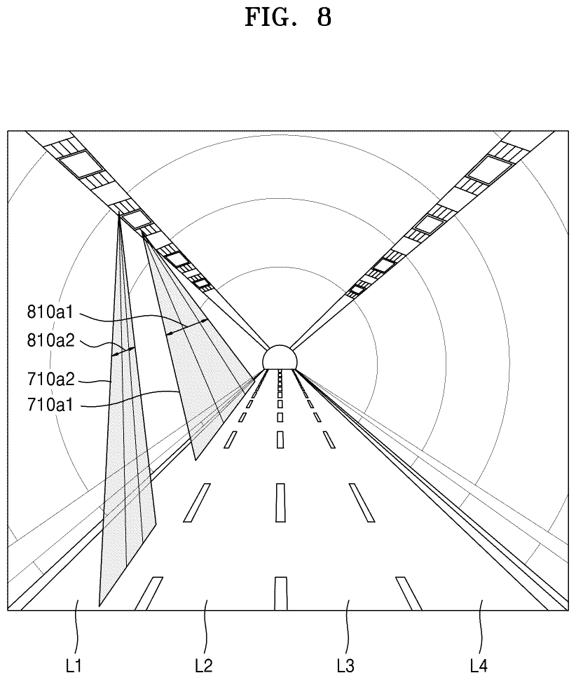

FIG. 8 is a diagram illustrating a state in which the pseudo-GNSS signals are output forward and backward in the tunnel, according to an embodiment.

According to an embodiment, the plurality of GNSS antennas 232a1, 232a2, 232b1, 232b2, 232c1, 232c2, 232d1, and 232d2 may output pseudo-GNSS signals forward and backward in the tunnel 410. A process of outputting the pseudo-GNSS signal for the first lane L1 is described with reference to FIG. 8. For the second lane L2, the third lane L3, and the fourth lane L4, the pseudo-GNSS signals may also be output forward and backward in the tunnel 410, as described with reference to FIG. 8. The term “forward” may refer to the exit direction of the tunnel 410 and the term “backward” may refer to the entrance direction of the tunnel 410.

According to an embodiment, the GNSS antenna 232a1 may output a first forward output signal 710a1 forward in the tunnel 410. The GNSS antenna 232a2 may output a first backward output signal 710a2 backward in the tunnel 410. According to an embodiment, the pseudo-GNSS signal output system 100 may output the pseudo-GNSS signal forward and backward by using the GNSS antenna corresponding to “forward” and the GNSS antenna corresponding to “backward,” thereby expanding the coverage of the pseudo-GNSS signal by the remote device 120. In addition, the pseudo-GNSS signal output system 100 has an effect of increasing the reception success rate when the vehicle receives the pseudo-GNSS signal by expanding the coverage of the pseudo-GNSS signal.

In addition, according to an embodiment, each of the GNSS antennas 232a1, 232a2, 232b1, 232b2, 232c1, 232c2, 232d1, and 232d2 may adjust magnitudes 810a1 and 810a2 of the azimuth of the pseudo-GNSS signal. The signal generation module 230 may adjust the angle magnitude of the azimuth of each of the GNSS antennas 232a1, 232a2, 232b1, 232b2, 232c1, 232c2, 232d1, and 232d2. For example, the angle magnitude of the azimuth may be set differently according to the velocity of the vehicle in each of the lanes L1, L2, L3, and L4.

In addition, according to an embodiment, the angle magnitudes 810a1 and 810a2 of the azimuths of the forward output signal 710a1 and the backward output signal 710a2 of the GNSS antennas 232a1, 232a2, 232b1, 232b2, 232c1, 232c2, 232d1, and 232d2 may be set differently from each other. In addition, the output power of the forward output signal 710a1 and the output power of the backward output signal 710a2 may be set differently.

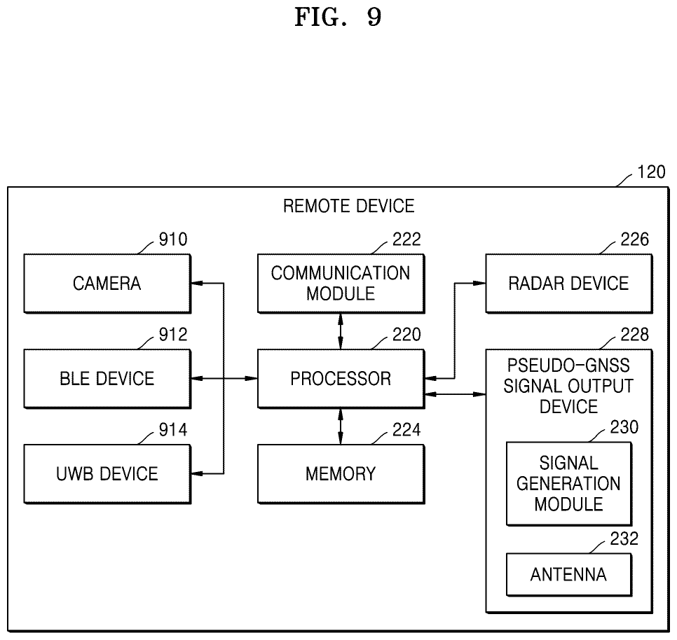

FIG. 9 is a block diagram illustrating the structure of the remote device according to an embodiment.

According to an embodiment, the remote device 120 may include a processor 220, a communication module 222, a memory 224, a RADAR device 226, a pseudo-GNSS signal output device 228, a camera 910, a BLE device 912, and a UWB device 914. In FIG. 9, the differences from the block diagram of FIG. 2 are mainly described.

The camera 910 may capture an image of a vehicle traveling on a lane. The camera 910 may generate a real-time captured image and generate visual information about the lane. The processor 220 may recognize the vehicle from the captured image. The processor 220 may match the vehicle recognized from the captured image with a vehicle recognized from a detection signal of the RADAR device 226 and may display the location and velocity of the vehicle on the captured image. The processor 220 may transmit the captured image to the main device 110.

According to an embodiment, the main device 110 or the remote device 120 may identify a license plate number of the vehicle by using the captured image of the camera 910. The main device 110 or the remote device 120 may recognize the licensed plate number on the vehicle and may match the identified vehicle with the licensed plate number of the vehicle. The main device 110 may collect location, velocity, and licensed plate number information of the vehicle.

The BLE device 912 may output a BLE beacon (or a BLE anchor). The BLE device 912 may output a BLE beacon to provide information about a location in the tunnel as identification information obtained from the BLE beacon.

According to an embodiment, the vehicle may pre-store a BLE map indicating the location of each BLE device 912 in the tunnel 410. When the vehicle receives the BLE beacon, the vehicle may identify the location in the tunnel by using the identification information in the BLE beacon and the pre-stored BLE map. The vehicle may pre-install a certain program or application and use information or functions stored in the program or application. The program or application of the vehicle may identify the location in the tunnel by using the BLE beacon.

According to an embodiment, the vehicle may know the reception angle of the BLE signal by using a received signal strength indicator (RSSI) phase of the BLE signal. In addition, the vehicle may measure the attenuation of the BLE signal by using the RSSI value and measure the distance from the BLE device 912. The vehicle may use the program or application to detect the location of the vehicle based on the BLE map, the RSSI phase of the BLE signal, and the RSSI value of the BLE signal.

The UWB device 914 may perform UWB communication with the vehicle. When the vehicle has a UWB communication function, the information about the location in the tunnel may be obtained by receiving the UWB signal output from the UWB device 914. Because the UWB signal has directivity, the vehicle may determine the location by using the UWB signals when the vehicle receives the UWB signals from at least four points. For example, when the UWB signal transmits location information and a transmission time corresponding to each signal, the vehicle may obtain location information of the vehicle based on the delay time and location information of each UWB signal. In addition, according to an embodiment, the vehicle may store UWB map information including location information of the UWB device 914. The vehicle may detect the location by using UWB map information and UWB signals output from four or more UWB devices.

According to an embodiment, the remote device 120 may be installed together with an LED device disposed for lighting the tunnel 410. For example, the remote device 120 may be implemented integrally with the LED device. Because the remote device 120 is implemented integrally with the LED device, ease of installation may be improved.

According to an embodiment, the remote devices 120 may be disposed at a first interval and sub-remote devices (not shown) including the BLE device 912 and the UWB device 914 may be disposed between the remote devices 120 at a second interval shorter than the first interval. For example, the remote devices 120 may be disposed at a first interval of 150 m and the sub-remote devices may be disposed at a second interval of 20 m. For example, 5 to 7 sub-remote devices may be disposed between two remote devices 120. Because BLE and UWB have a short signal arrival range, the performance of BLE communication and UWB communication may be improved by additionally installing the sub-remote devices in the tunnel at an interval of 20 m.

In addition, according to an embodiment, the remote device 120 may include a plurality of RADAR reflectors (not shown) that reflect RADAR signals output from the RADAR device 226. The RADAR reflector may reflect an opposite signal in an exactly opposite direction. For a short-range RADAR, the arrival range may be about 100 m. However, when the RADAR signal is amplified by using the RADAR reflector, the arrival range of the RADAR signal may increase to about 150 m. The remote device 120 may increase the arrival range of the RADAR signal by using the RADAR reflector.

On the other hand, the embodiments may be implemented in the form of a computer-readable recording medium having recorded thereon instructions and data executable by a computer. The instructions may be stored in the form of program code and, when executed by a processor, may generate a certain program module and perform a certain operation. In addition, the instructions, when executed by a processor, may perform certain operations of the disclosed embodiments.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A pseudo-global navigation satellite system (GNSS) signal output system comprising:
a main device installed outside a tunnel; and
a plurality of remote devices installed inside the tunnel at a first interval and configured to communicate with the main device,
wherein each of the plurality of remote devices comprises:
a radio detection and ranging (RADAR) device configured to output a RADAR signal and detect a RADAR signal reflected from a target,
at least one pseudo-GNSS signal output device, and
a communication module configured to communicate with the main device; and
a processor configured to:
recognize a location and velocity of a vehicle traveling in the tunnel by using the RADAR signal detected by the RADAR device,
transmit the recognized location and velocity of the vehicle to the main device through the communication module,
receive pseudo-GNSS signal information from the main device through the communication module, and
generate and output a pseudo-GNSS signal through the at least one pseudo-GNSS signal output device by using the pseudo-GNSS signal information.

2. The pseudo-GNSS signal output system of claim 1, wherein the main device is configured to determine an angle magnitude of an azimuth and output power of a GNSS antenna that outputs the pseudo-GNSS signal based on the location and velocity of the vehicle received from each of the plurality of remote devices, and
wherein the pseudo-GNSS signal information comprises the angle magnitude of the azimuth and the output power.

3. The pseudo-GNSS signal output system of claim 1, wherein the main device is configured to:
communicate with each of the plurality of remote devices through an optical fiber cable;
transmit a delay measurement message for measuring an optical delay to each of the plurality of remote devices; receive a response message to the delay measurement message;
measure the optical delay between each of the plurality of remote devices and the main device, based on the response message; and
transmit the pseudo-GNSS signal information based on the optical delay.

4. The pseudo-GNSS signal output system of claim 3, wherein the main device is further configured to:
generate a coarse/acquisition (C/A) code by reflecting the optical delay of each of the plurality of remote devices into GNSS signal information received from a server; and
generate the pseudo-GNSS signal information comprising the generated C/A code.

5. The pseudo-GNSS signal output system of claim 1, wherein the main device is configured to generate the pseudo-GNSS signal in a form of in-phase and quadrature (IQ) modulated in a form of quadratic phase-shift keying (QPSK), and
wherein the pseudo-GNSS signal comprises a C/A code in a Q phase and a C/A code and an arbitrary P code in an I phase.

6. The pseudo-GNSS signal output system of claim 1, further comprising a plurality of directional GNSS antennas respectively corresponding to lanes of a road in the tunnel and configured to output a pseudo-GNSS signal to a corresponding lane,
wherein the pseudo-GNSS signal comprises lane information.

7. The pseudo-GNSS signal output system of claim 6, further comprising a forward GNSS antenna configured to output a pseudo-GNSS signal forward and a backward GNSS antenna configured to output a pseudo-GNSS signal backward.

8. The pseudo-GNSS signal output system of claim 6, wherein the processor of each of the plurality of remote devices is further configured to:
recognize the velocity of the vehicle traveling in each lane in the tunnel by using the RADAR signal; and
transmit the recognized velocity of the vehicle for each lane to the main device through the communication module, and
wherein the main device is configured to adjust an angle magnitude of an azimuth and output power of the GNSS antenna of each of the plurality of remote devices, based on the recognized velocity of the vehicle in each lane.

9. The pseudo-GNSS signal output system of claim 1, wherein each of the plurality of remote devices comprises a camera, and
wherein the processor is further configured to:
recognize the location, velocity, and licensed plate number of the vehicle traveling in the tunnel, based on the RADAR signal detected by the RADAR device and an image captured by the camera; and
transmit the recognized location, velocity, and licensed plate number of the vehicle to the main device.

10. The pseudo-GNSS signal output system of claim 1, wherein each of the plurality of remote devices further comprises a Bluetooth Low Energy (BLE) device configured to output a Bluetooth signal, and
wherein the vehicle in the tunnel is configured to:
store BLE map information comprising location and identification information of the BLE device of each of the plurality of remote devices;
calculate an angle at which a Bluetooth signal is received from the BLE device, by using the BLE map information and a received signal strength indicator (RSSI) phase of the Bluetooth signal output from the BLE device; and
measure a distance from the BLE device by using the BLE map information and an RSSI value.

11. The pseudo-GNSS signal output system of claim 1, wherein each of the plurality of remote devices further comprises an Ultra-Wideband (UWB) device configured to output a UWB signal, and
wherein the vehicle in the tunnel is configured to:
store UWB map information comprising location and identification information of the UWB device of each of the plurality of remote devices; and
detect the location of the vehicle by using the UWB map information and UWB signals output from four or more UWB devices.

12. A pseudo-global navigation satellite system (GNSS) signal output method of outputting a pseudo-GNSS signal in a plurality of remote devices disposed in a tunnel, the pseudo-GNSS signal output method comprising:
outputting a radio detection and ranging (RADAR) signal from a RADAR device of each of the plurality of remote devices;
recognizing a location and velocity of a vehicle traveling in the tunnel by using the RADAR signal detected by the RADAR device;
transmitting the recognized location and velocity of the vehicle to a main device disposed outside the tunnel;
receiving pseudo-GNSS signal information from the main device; and
generating and outputting a pseudo-GNSS signal through at least one pseudo-GNSS signal output device by using the pseudo-GNSS signal information.
